(19) United States
(12) Patent Application Publication
(10) Pub. No.: US 2026/0339632 A1
(43) Pub. Date: Oct. 29, 2026

(54) METHOD AND APPARATUS WITH COMPILER

(71) Applicant: SAMSUNG ELECTRONICS CO., LTD., Suwon-si (KR)

(72) Inventors: Sanggyu SHIN, Suwon-si (KR); Seungbin SONG, Suwon-si (KR); Hanwoong JUNG, Suwon-si (KR)

(73) Assignee: SAMSUNG ELECTRONICS CO., LTD., Suwon-si (KR)

(21) Appl. No.: 19/359,932

(22) Filed: Oct. 16, 2025

(30) Foreign Application Priority Data
Apr. 25, 2025 (KR) 10-2025-0054672
Jun. 26, 2025 (KR) 10-2025-0085316

(51) Int. Cl. G06F 8/41; G06F 8/35

(52) U.S. Cl. CPC G06F 8/443; G06F 8/35

(57) ABSTRACT

A processor-implement method including extracting a first intermediate representation (IR) corresponding to predetermined code regions by identifying the predetermined code regions in an initial IR, providing the extracted first IR to a large language model (LLM) to obtain a second IR, performing multi-stage verification on the second IR, and integrating, into the initial IR, the second IR responsive to a completion of the multi-stage verification to generate a third IR.

### CROSS-REFERENCE TO RELATED APPLICATIONS

This application claims the benefit under 35 USC § 119(a) of Korean Patent Application No. 10-2025-0054672, filed on Apr 25, 2025, and Korean Patent Application No. 10-2025-0085316, filed on Jun 26, 2025, in the Korean Intellectual Property Office, the entire disclosures of which are incorporated herein by reference for all purposes.

### BACKGROUND

### 1. FIELD

The following description relates to a method and apparatus with compiler operations.

### 2. Description of Related Art

A compiler is a software tool that converts source code written in a high-level programming language into machine code that may be executed by a computer. In general, a compiler first converts source code into intermediate code called an intermediate representation (IR), and an IR is designed to be used universally without being dependent on a predetermined programming language or hardware.

Using an IR may facilitate code optimization and effectively support various programming languages and hardware environments. In this optimization process, it is typical for various analysis and transformation operations to be performed to improve code performance, reduce code size, increase execution efficiency, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including extracting a first intermediate representation (IR) corresponding to predetermined code regions by identifying the predetermined code regions in an initial IR, providing the extracted first IR to a large language model (LLM) to obtain a second IR, performing multi-stage verification on the second IR, and integrating, into the initial IR, the second IR responsive to a completion of the multi-stage verification to generate a third IR.

The performing of the multi-stage verification may include, responsive to an error being found during the multi-stage verification, repeatedly generating and re-verifying a modified second IR by correcting the error using the LLM.

The repeatedly generating and re-verifying may include performing verification while within a range of a preset constraint condition.

The performing of the multi-stage verification may include performing syntactic analysis on the second IR to determine a presence of a grammatical error, semantically verifying whether a second functional operation of the second IR is the same as a first functional operation of the first IR, and evaluating logical consistencies of the second IR to identify one or more of a conflict and inconsistency between IRs.

The method may include identifying, through a runtime simulation, an operation of the second IR based on input data.

The providing of the extracted first IR may include generating a prompt corresponding to the extracted first IR and providing, to the LLM, the extracted first IR and the prompt.

The integrating may include inserting an error-free second IR, responsive to an error free result of the multi-stage verification, to the initial IR.

The method may include, responsive to the multi-stage verification exceeding a preset constraint condition terminating the multi-stage verification and integrating, into the initial IR, a first code region of the first IR corresponding to a failed code region of the second IR for which the multi-stage verification fails.

The method may include, responsive to the multi-stage verification exceeding a preset constraint condition, terminating the multi-stage verification and maintaining the initial IR corresponding to the second IR for which the multi-stage verification fails.

The extracting of the first IR may include extracting the first IR at an arbitrary optimization pass position in a pipeline of a compiler.

The predetermined code regions may include one of a function, a loop, or a pragma.

The method may include providing the third IR is to a pipeline of a compiler to be processed in a subsequent pass of the compiler.

In a general aspect, here is provided an electronic device including one or more processors including processing circuitry and memory including one or more storage media storing instructions that, when executed individually or collectively by the one or more processors, cause the electronic device to extract a first intermediate representation (IR) corresponding to predetermined code regions by identifying the predetermined code regions in an initial IR, provide the extracted first IR to a large language model (LLM) to obtain a second IR, perform multi-stage verification on the second IR, and integrate, into the initial IR, the second IR responsive to a completion of the multi-stage verification to generate a third IR.

The execution of the instructions may cause the electronic device to, responsive to an error being found during the multi-stage verification, iteratively generate and re-verify a modified second IR by correcting the error using the LLM.

The execution of the instructions may cause the electronic device to perform verification while within a range of a preset constraint condition.

The execution of the instructions may cause the electronic device to perform syntactic analysis on the second IR to determine a presence of a grammatical error, semantically verify whether a second functional operation of the second IR is the same as a first functional operation of the first IR, and evaluate logical consistencies of the second IR to identify one or more of a conflict and inconsistency between IRs.

The execution of the instructions may cause the electronic device to identify, through a runtime simulation, an operation of the second IR based on input data.

The execution of the instructions may cause the electronic device to generate a prompt corresponding to the extracted first IR and provide, to the LLM, the extracted first IR and the prompt.

The execution of the instructions may cause the electronic device to insert an error-free second IR, responsive to an error free result of the multi-stage verification, to the initial IR.

In a general aspect, here is provided a non-transitory, machine-readable storage medium storing instructions that, when executed by one or more processors, cause the one or more processors to perform a method including extracting a first intermediate representation (IR) corresponding to predetermined code regions by identifying the predetermined code regions in an initial IR, providing the extracted first IR to a large language model (LLM) to obtain a second IR, performing multi-stage verification on the second IR, and integrating, into the initial IR, the second IR responsive to a completion of the multi-stage verification to generate a third IR.

### BRIEF DESCRIPTION OF THE DRAWINGS

FIG. 1 illustrates an example method with compiler operations according to one or more embodiments.

FIG. 2 illustrates an example process of optimizing an intermediate representation (IR) of a compiler according to one or more embodiments.

FIG. 3 illustrates an example method IR optimization according to one or more embodiments.

FIG. 4 illustrates an example large language model (LLM) optimizer according to one or more embodiments.

FIG. 5 illustrates an example verifier according to one or more embodiments.

FIG. 6 illustrates an example process of a compiler pass including an LLM optimizer according to one or more embodiments.

FIG. 7 illustrates an example result of an IR optimization according to one or more embodiments.

FIG. 8 illustrates an example low-level virtual machine (LLVM)-based compiler architecture according to one or more embodiments.

FIG. 9 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term "may" herein with respect to an example or embodiment (e.g., as to what an example or embodiment may include or implement) means that at least one example or embodiment exists where such a feature is included or implemented, while all examples are not limited thereto. The use of the terms "example", "embodiment", and "example embodiment" herein have a same meaning (e.g., the phrasing 'in an or one example' has a same meaning as 'in an or one embodiment" and 'in an or one example embodiment'), and "one or more examples" has a same meaning as "one or more embodiments" and "one or more example embodiments". Still further, each of multiple or all separately described an/one "example", "embodiment", "example embodiment", as well as "examples", "embodiments", "example embodiments", herein may be included, in combination, in a same embodiment in any combination.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

The examples may be implemented as various types of products such as, for example, a personal computer, a laptop computer, a tablet computer, a smartphone, a television, a smart home appliance, an intelligent vehicle, a kiosk, and a wearable device. Hereinafter, the examples are described in detail with reference to the accompanying drawings. When describing the examples with reference to the accompanying drawings, like reference numerals refer to like elements and a repeated description related thereto will be omitted.

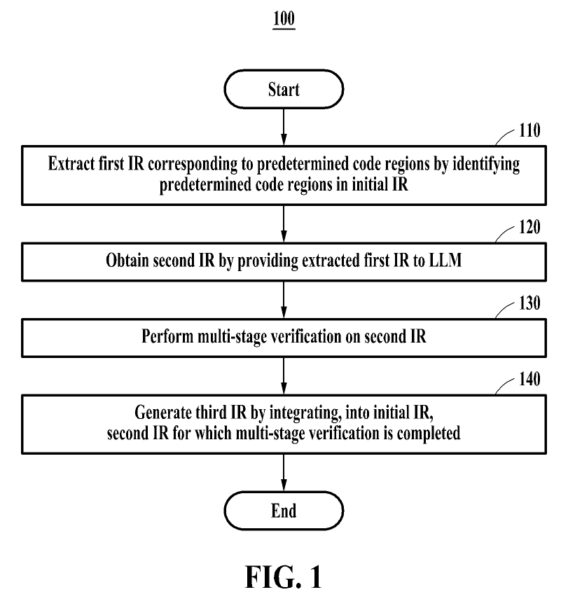

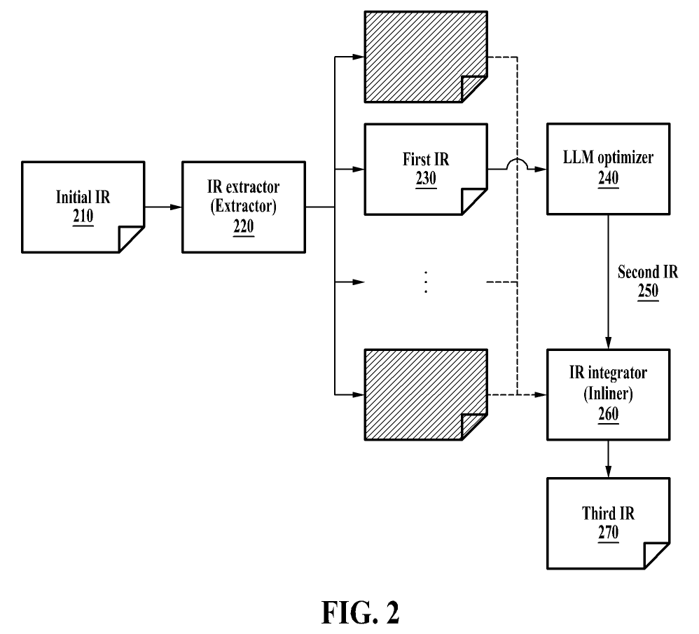

FIG. 1 illustrates an example method with compiler operations according to one or more embodiments. FIG. 2 illustrates an example process of optimizing an intermediate representation (IR) of a compiler according to one or more embodiments.

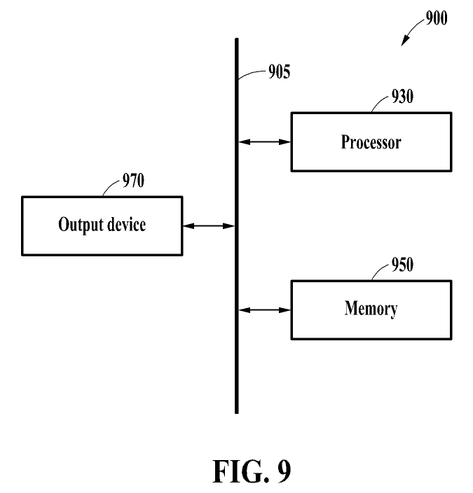

For ease of description, operations 110 to 140 are described as being performed using an electronic device 900 as illustrated below in FIG. 9. However, operations 110 to 140 may be performed by another suitable electronic device in a suitable system.

Furthermore, the operations shown in FIG. 1 may be performed in the shown order and manner. However, the order of some operations may change, or some operations may be omitted without departing from the spirit and scope of the shown example. The operations illustrated in FIG. 1 may be performed in parallel or simultaneously.

A compiler may be a program or software tool that converts source code written in a programming language into machine code that may be executed on a computer. The compiler may perform code conversion and optimization without directly converting source code into machine language, usually through an intermediate representation (IR).

An IR may be a platform-independent and programming language-independent abstract code representation that exists between source code and machine code. The IR may typically be generated in various programming languages and converted to various hardware platforms, which may play a role in efficient code optimization and increasing code reusability.

Referring to first to FIG. 2, in a non-limiting example, an electronic device (e.g., electronic device 900) may include an IR extractor 220 that extracts a first IR 230 from an initial IR 210, an LLM optimizer 240 that optimizes and repeatedly verifies the first IR 230, and an IR integrator 260 (e.g., an inliner) that integrates a second IR 250 into the initial IR 210 to generate a third IR 270, which is a final IR. In this case, when the second IR 250 fails verification and is determined to be not a normal IR, the electronic device 900 may integrate the first IR 230 into the third IR 270 instead of the second IR 250.

In an example, an electronic device (e.g., the electronic device 900) may also perform the above-described process on a plurality of IRs. For example, when multiple code regions are identified and multiple first IRs 230 are extracted from the initial IR 210, the LLM optimizer 240 may generate multiple optimized second IRs 250, accordingly. When some of the generated plurality of second IRs 250 fail multi-stage verification while some succeed, the electronic device 900 may integrate, into the intial IR 210, only the second IRs 250 for which verification is successful, discard the second IRs 250 for which verification fails, and then re-integrate the original first IR 230 into a corresponding region to generate the third IR 270. Alternatively, the electronic device 900 may discard the second IRs 250 for which verification fails and keep the corresponding region of the initial IR 210 unchanged to generate the third IR 270.

Referring to FIG. 1, in a non-limiting example, method 100 may include operation 110, in which an electronic device (e.g., the electronic device 900) may identify predetermined code regions in an initial IR (e.g., the initial IR 210) and extract a first IR (e.g., the first IR 230) corresponding to the predetermined code regions.

A predetermined code region may be a region including at least one of a function, a loop, or a pragma.

In an example, an electronic device (e.g., electronic device 900) may analyze the initial IR (e.g., initial IR 210) generated by the compiler from the source code to determine a region that may benefit from, or require, optimization. In operation 110, to find an area that may benefit from optimization, a code region may be identified as having a predetermined pattern within the initial IR. For example, the identified predetermined code region may be a region with low code execution efficiency, a region including redundant operations, or a region that has a large impact on performance due to repeated execution.

For example, in operation 110, the electronic device (e.g., electronic device 900) may extract the first IR (e.g., first IR 230) at an arbitrary optimization pass position within a pipeline of the compiler.

A pass may be an independent processing unit within a compiler that performs predetermined analysis or conversion using an IR as an input. Each pass may have the purpose of improving the quality of code or applying optimization. For example, the purpose may include removing unnecessary code, converting a loop, inline processing, register allocation, and the like.

A plurality of passes may be executed sequentially or in a combinatorial manner within the pipeline of the compiler, contributing to improved execution performance of the overall program and increased execution efficiency of code.

In an example, in operation 110, an electronic device (e.g., electronic device 900) may identify a boundary of a predetermined code region by analyzing metadata, structural information, or annotation information included in the initial IR (e.g., IR 210). For example, a code region (or a block) may be extracted based on an instruction pattern that indicates the start and end of a loop or the scope of a function definition.

An optimization candidate may be selected based on the complexity or operational intensity of a code region. For example, a nested loop structure or a loop structure with a large number of repetitions, a function with a complex conditional branch, or the like may be identified as a predetermined code region.

In an example, an electronic device (e.g., electronic device 900) may identify a plurality of predetermined code regions in parallel and sequentially or simultaneously extract a plurality of first IRs (e.g., one or more first IR’s 230) corresponding to the respective code regions.

The extracted first IR may be used as data to be input to an LLM in a later stage. For example, the LLM may be implemented as an internal server or an external service. For example, the LLM may be implemented as an application processing interface (API) in the form of an internal server or an external service.

In an example, in operation 120, an electronic device (e.g., the electronic device 900) may provide the extracted first IR (e.g., first IR 230) to the LLM to obtain a second IR (e.g., the second IR 250).

In an example, an electronic device (e.g., electronic device 900) may generate a prompt corresponding to the extracted first IR (e.g., first IR 230) and provide the extracted first IR and the prompt to the LLM.

When generating a prompt, an appropriate context may be configured based on information such as a code structure, an instruction pattern, a control flow, and an operation type of the first IR. For example, when the first IR includes a nested loop, a repetition condition of the loop, the complexity of an internal operation, a data access pattern, and the like may be summarized and included as input elements of the prompt. The prompt may be in natural language or predefined instruction format and may be written so that the LLM may clearly understand the purpose of an optimization task.

The electronic device may include the prompt and the first IR together as input data and transmit a request for the input data to the LLM. The request may be transmitted synchronously or asynchronously. The LLM may respond by analyzing the input data and generating an optimized second IR (e.g., second IR 250) for a corresponding code block. For example, the LLM may apply various optimization techniques such as changing the order of operations, removing redundant operations, removing unnecessary variable declarations, and parallelizing memory access techniques or operational units.

In an example, in operation 120, an electronic device (e.g., electronic device 900) may also transmit the plurality of first IRs (e.g., first IR’s 230) to the LLM in parallel. In this case, a prompt may be generated independently for each first IR, and a second IR (second IR 250) may be received independently from the LLM and used for a subsequent operation. This parallel optimization technique may contribute to improving the overall compilation optimization speed and maintaining consistent optimization quality for a plurality of code blocks.

In addition, the electronic device may temporarily store finally received second IRs in a memory or storage and use the finally received second IRs as input values for a verification operation and an integration operation performed in subsequent operations. The electronic device may assign an identifier to the second IR obtained from the LLM to distinguish the second IR from the original first IR or store the second IR together with meta information. This may allow appropriate restoration or comparison in case of later verification failures.

In an example, in operation 130, an electronic device (e.g., the electronic device 900) may perform multi-stage verification on a second IR (e.g., second IR 250).

When an error is found in a verification stage, the electronic device may repeatedly generate and re-verify a modified IR by correcting the error using the LLM.

Verification may be performed in method 100 within a range that does not exceed a preset constraint condition. The preset constraint condition may include a maximum number of iterations and a maximum verification time. For example, the electronic device may terminate verification when either the maximum number of iterations or the maximum verification time is exceeded during a verification process. The maximum number of iterations and maximum verification time may be determined based on settings of a user or an internal condition of a system.

In an example, in operation 130, the electronic device may perform syntactic analysis on the second IR to determine whether there is a grammatical error within the second IR. Here, the electronic device may semantically verify whether a functional operation of the second IR is the same as a functional operation of the first IR. The logical consistency of the second IR may be evaluated to identify conflicts or inconsistency between IRs.

In an example, the electronic device may verify an operation of the second IR for input data through a runtime simulation.

Thus, in operation 130, the electronic device may identify whether syntactic elements of the code are correctly aligned and disposed during a syntax analysis stage. For example, syntactic elements such as curly brackets, parentheses, and command terminators may be considered. When detecting a syntax error, the electronic device may record an error position and an error type and then transmit a request for correction to the LLM based on corresponding information.

The electronic device may compare an output result of the first IR to an output result of the second IR and determine functional sameness by analyzing whether there is a change in a function call structure of data flow. For example, when the same output does not occur for the same input value, the electronic device may determine that there is semantic inconsistency.

That is, in a logical consistency evaluation stage, a data flow between variables, a conditional branching structure, repetitive control flows, and the like are analyzed to determine whether they are logically connected. For example, when a variable value defined in a conditional statement is referenced externally, it may be possible to identify whether a valid variable scope is violated.

The electronic device may determine whether corresponding code is terminated normally without generating an exception by executing the second IR together with an arbitrary dummy input at a runtime simulation stage. The electronic device may record whether verification is successful or not based on an error log or an output value that occurs during a simulation.

When an IR modified in repeated verification repeatedly or continuously fails the verification process, the electronic device may stop the verification and return to the previous stage after checking a preset constraint condition. The electronic device may discard or record the second IR that failed the verification process in a log and may later use that fail record for comparison or analysis material. For example, when the maximum number of iterations is set to 5 and the maximum verification time is set to 3 minutes, additional verification may be terminated without proceeding when the verification time exceeds 3 minutes, even if the number of iterations does not reach 5.

In an example, in operation 140, an electronic device (e.g., the electronic device 900) may integrate a verified second IR (e.g., second IR 250) into an initial IR (e.g., the initial IR 210) to generate a third IR (e.g., the third IR 270).

For example, depending on a verification result, the electronic device may optionally insert only the second IR having no errors into the initial IR.

The multi-stage verification may be terminated when the multi-stage verification exceeds the preset constraint condition. For example, when the maximum number of iterations is set to 5 and the maximum verification time is set to 3 minutes, the electronic device may terminate a multi-stage verification process when the number of iterations of the multi-stage verification exceeds 5 or the time taken for the multi-stage verification exceeds 3 minutes.

The electronic device may integrate, into the initial IR, the first IR which correspond to a predetermined code region corresponding to the second IR that failed its verification or maintain the initial IR which corresponds to the predetermined code region that corresponds to the second IR with the failed verification.

The third IR may be provided to the pipeline of the compiler and processed in a subsequent pass of the compiler.

In operation 140, the electronic device may individually determine whether to perform integration based on the verification state of the second IR. For example, when each of a plurality of predetermined code regions is independently extracted and generated as the second IR, only the second IR for which verification is successful may be inserted as an option and a region for which verification fails may be excluded from an integration target. For example, when the number of iterations for the second IR of a predetermined code region A does not exceed the maximum number of iterations of 10, but the verification time for the second IR for a predetermined code region B exceeds the maximum verification time of 5 minutes, the electronic device may stop additional verification for the code region B and integrate the existing first IR or maintain the initial IR.

The third IR 270 may be configured in such a way that, for a region for which verification fails, that failed region may be reverted to the original first IR, or the initial IR 210 may be maintained as is without performing any modification. In this case, the electronic device may select which technique is a more stable integration technique according to a preset policy.

In an example, in operation 140, the electronic device may check a boundary condition between IRs during integration to ensure that the optionally inserted second IR does not collide with other code regions. For example, the optimized second IR may be adjusted so as to not exceed a function boundary or to not conflict with a variable scope.

In an example, in operation 140, identification information may be provided to the integrated third IR or, the electronic device may record whether the integration is successful or not to use that information for analysis and debugging in a subsequent pass. For example, a successfully integrated code block may have an integration tag inserted, while a failed region may have a reason for processing left in the form of an annotation.

Finally, the electronic device may finally store or register the third IR in the memory and then pass the third IR to a subsequent pass of the compiler to be processed in a subsequent optimization or code generation stage. For example, a subsequent pass may perform inline processing on an optimized loop or a function block included in the third IR or perform an operation of converting the optimized loop or function block into an architecture-specific instruction set.

The description provided with reference to FIG. 1 may also apply to FIG. 2, and any repeated description related thereto may be omitted.

Referring back to FIG. 2, the electronic device (e.g., the electronic device 900) may include the IR extractor 220, the LLM optimizer 240, and the IR integrator 260.

The IR extractor 220 may identify a predetermined code region to be optimized in the initial IR 210 and extract the first IR 230 corresponding to the region. The IR extractor 220 may be disposed at a predefined pass position within a compiler pipeline and may automatically search for and isolate a code region requiring optimization based on a function unit, a loop block, a pragma instruction, and the like. For example, code including a nested loop structure or a computationally intensive block may be extracted as a predetermined code region.

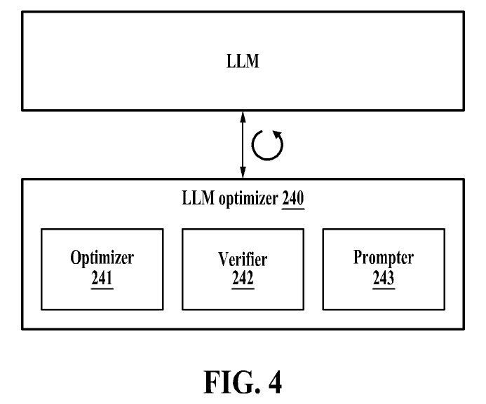

The LLM optimizer 240 may perform optimization based on an LLM using the extracted first IR 230 as an input and may perform multi-stage verification and error correction on the result. Referring to FIG. 4 below, the LLM optimizer 240 may include a prompter 243, an optimizer 241, and a verifier 242.

In an example, the prompter 243 may configure, or generate, a prompt suitable for an optimization purpose by analyzing a structure, an operation pattern, a repetition condition, variable usage information, and the like of the first IR 230.

In an example, the optimizer 241 may provide the prompt and the first IR 230 to the LLM, obtain the optimized second IR 250, convert the optimized second IR 250 into an internal format, and output the converted optimized second IR 250.

In an example, the verifier 242 may perform multi-stage verification, such as syntactic analysis, semantic verification, logical consistency evaluation, a runtime simulation, and the like on the second IR 250, and may control repeated execution by transmitting a request for re-optimization to the optimizer 241.

The LLM optimizer 240 may limit the number of re-verifications or a re-verification time based on a preset constraint condition.

Referring back to FIG. 2, the IR integrator 260 may integrate, into the initial IR 210, the second IR 250 for which verification is successful to generate the third IR 270, which is a final IR.

The IR integrator 260 may select only second IRs for which verification is successful among a plurality of second IRs 250 corresponding to a plurality of predetermined code regions and insert the selected second IRs to a corresponding region. The IR integrator 260 may provide stability by re-inserting the extracted first IR 230 to a region for which verification fails or maintaining a corresponding region of the initial IR 210. The IR integrator 260 may transmit the integrated third IR 270 to a subsequent pass of the compiler for use in a subsequent task such as code generation, architecture-specific conversion, and additional optimization.

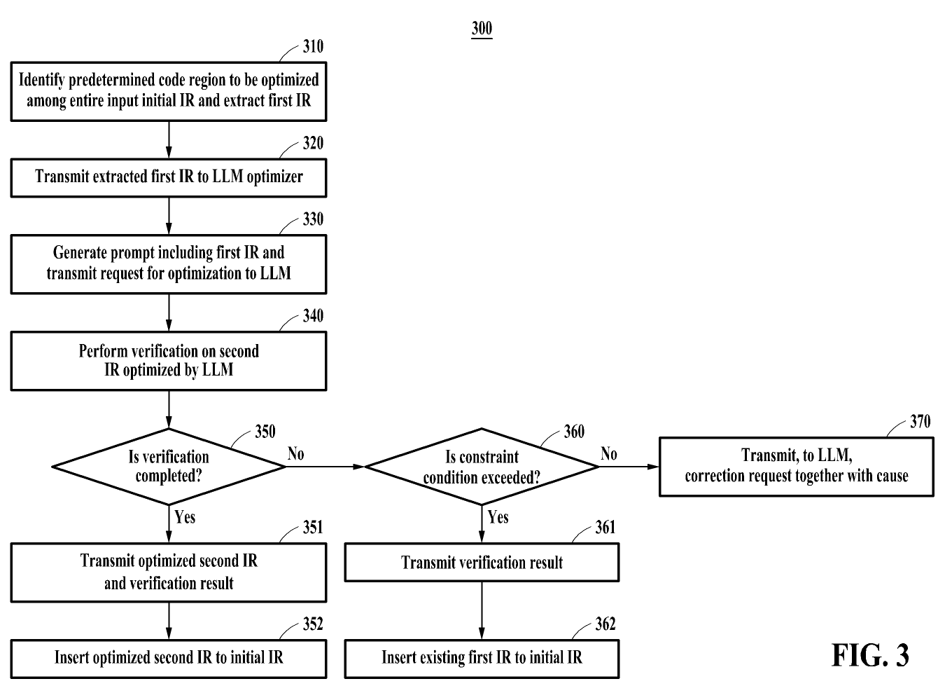

FIG. 3 illustrates an example method IR optimization according to one or more embodiments.

The description provided with reference to FIGS. 1 and 2 may apply to FIG. 3, and any repeated description related thereto may be omitted.

Referring to FIG. 3, in a non-limiting example, method 300 may include operation 310, in which an electronic device (e.g., the electronic device 900) may identify a predetermined code region to be optimized among an entire initial IR (e.g., initial IR 210), which is input, and to then extract a first IR (e.g., the first IR 230) corresponding to the code region. The electronic device may perform analysis based on a predefined criterion such as a loop, a function, or a pragma region, and automatically search for a code block in which optimization is determined to be meaningful. The extracted first IR may then become a basic input unit subject to LLM-based optimization processing.

In an example, in operation 320, an electronic device (e.g., the electronic device 900) may transmit the extracted first IR to an optimizer such as an LLM optimizer (e.g., the LLM optimizer 240). In this case, the LLM optimizer may include a prompter, optimizer, verifier (e.g., the prompter 243, the optimizer 241, the verifier 242 of FIG. 4), and the like. The first IR may be used as an input for subsequent prompt generation and LLM optimization. The electronic device may transmit corresponding data via a network or an internal interface.

In an example, in operation 330, an electronic device (e.g., the electronic device 900) may generate a prompt including the first IR 230 and transmit a request for optimization to an LLM together with the prompt. The prompt may include information describing the structure, operation characteristics, optimization purpose, and the like of the first IR and may assist the LLM in performing accurate and efficient optimization.

In an example, in operation 340, an electronic device (e.g., the electronic device 900) may perform verification on a second IR (e.g., the second IR 250) that was optimized by the LLM. The electronic device may perform a multi-stage verification procedure such as syntactic analysis, semantic comparison, logical consistency evaluation, and a runtime simulation on the second IR and may perform repeated evaluations until the verification is completed. The verification may be performed by the optimizer’s verifier, and whether there is an error may be a criterion for determining a subsequent branch condition.

In an example, in operation 350, an electronic device (e.g., the electronic device 900) may determine whether the second IR passes the verification. When it is determined that the verification is successfully completed, the method 300 may proceed to operation 351, and, in an example, when it is determined that the verification fails, the method 300 may proceed to operation 360 where, in an example, it may be determined whether to repeat the process thereafter.

In operation 351, the electronic device may transmit the optimized second IR and a verification result to an internal processing module or a subsequent pipeline. The transmitted result may include information on whether verification is successful or fails, an optimization log, a structural change, and the like. The transmitted result may be used as a criterion for subsequent integrated processing.

In an example, in operation 352, an electronic device (e.g., the electronic device 900) may insert the optimized second IR to the initial IR. Examples, of the insertion may be performed while structural consistency is maintained, and the entire IR configured after the insertion may be transmitted to the next compilation stage as the final result.

In an example, in operation 360, an electronic device (e.g., the electronic device 900) may determine whether the verification conducted so far exceeds a preset constraint condition responsive to the second IR failing its verification. A number of iterations is set as an upper bound to ensure the stability of a verify-modify loop, and whether the upper bound is exceeded or not may affect a subsequent processing branch determination. The preset constraint condition may be determined experimentally or may be arbitrarily set by a user. In addition, the electronic device may arbitrarily adjust the preset constraint condition according to an internal resource allocation rate.

In an example, in operation 361, an electronic device (e.g., the electronic device 900) may transmit a corresponding verification result to an internal processing flow when the number of verification iterations or a verification time exceeds the constraint condition. A result of failing the verification and/or exceeding the constraint condition for verification may be considered a state in which an optimized result is not accepted, and, as a result, a restoration, or an alternative action, may be taken thereafter.

In an example, in operation 362, an electronic device (e.g., the electronic device 900) may insert the existing first IR to the initial IR. This operates in a way to discard the second IR that failed it verification and also to maintain an existing code block which may guarantee its stability, thereby ensuring a reliability of the entire IR.

In an example, in operation 370, an electronic device (e.g., the electronic device 900) may transmit a correction request to the LLM. In this case, the electronic device may provide the LLM with a cause, such as an error occurrence point and an error type, and may transmit a request for newly generating a corrected second IR to the LLM. Operation 370 may be performed in instances in which the verification has failed but a number of iterations or a verification time for that verification did not exceed the constraint condition, and a generated result may be returned to the verification loop again.

FIG. 4 illustrates an example large language model (LLM) optimizer according to one or more embodiments.

The description provided with reference to FIGS. 1- 3 may apply to FIG. 4, and any repeated description related thereto may be omitted.

Referring to FIG. 4, in a non-limiting example, the LLM optimizer 240 may perform a series of functions of receiving an IR as an input, performing optimization through an LLM, verifying a generated result, and then outputting the generated result appropriately. The LLM optimizer 240 may include the optimizer 241, the verifier 242, and the prompter 243. The optimizer 241, the verifier 242, and the prompter 243 may each be implemented as an independent processing element or may be implemented as functions that are sequentially performed according to instructions in one processor. In addition, the optimizer 241, the verifier 242, and the prompter 243 may be implemented in software and configured in the form of a hardware circuit or firmware.

In an example, the prompter 243 may generate a prompt in a form that an LLM may understand by analyzing the context, structure, operation characteristics, and the like of an extracted first IR (e.g., first IR 230). The prompter 243 may configure a prompt including information such as a loop repetition structure, an operation flow, and a variable to be used. The generated prompt may be transmitted to the optimizer 241 together with the first IR.

In an example, the optimizer 241 may transmit an optimization request to the LLM based on the prompt provided from the prompter 243 and the first IR and receive a second IR (e.g., second IR 250) in response thereto. The optimizer 241 may access a locally disposed LLM server through an internal network or connect to a cloud-based LLM by calling an application programming interface (API) in the form of an external service. For example, the optimizer 241 may communicate with various types of engines such as OpenAI, Google Cloud, or an in-house LLM server.

In an example, the verifier 242 may perform verification on the second IR that was received from the optimizer 241. The verifier 242 may include grammatical error detection, semantic equivalence verification, logical consistency evaluation, a runtime simulation, and the like through multi-stage verification. For example, the verifier 242 may detect errors in matching curly brackets, inconsistency in variable definition and usage, and conflicts within a branch structure and may also perform an execution test using a dummy input to determine whether an actual operation is stable. When verification fails, the verifier 242 may transmit the cause and position information back to the optimizer 241 to induce re-optimization.

The LLM optimizer 240 operates based on the actions of the prompter 243, the optimizer 241, and the verifier 242, as discussed above, but the optimizer 240 may not be limited to these components. For example, the LLM optimizer 240 may further include a logging module that stores optimization logs, a policy manager that reflects user settings, an interface cache module that caches LLM responses, and the like. Therefore, the configuration of the LLM optimizer 240 should not be interpreted as being limited to the configuration described herein, and various modifications and extensions may be possible.

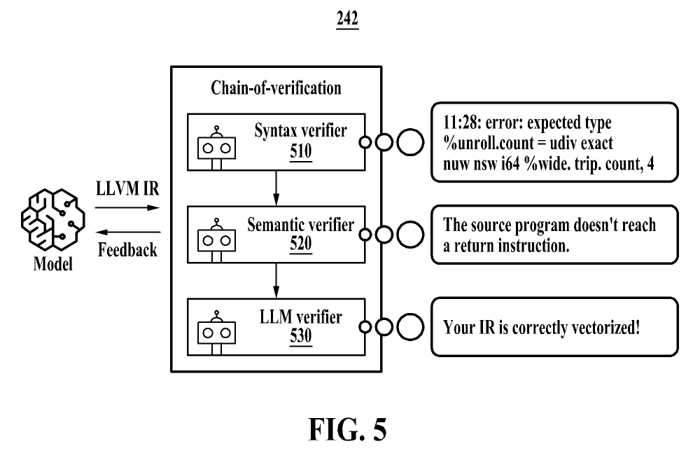

FIG. 5 illustrates an example verifier according to one or more embodiments.

The description provided with reference to FIGS. 1 - 4 may apply to FIG. 5, and any repeated description related thereto may be omitted.

Referring to FIG. 5, in a non-limiting example, the verifier 242 in the LLM optimizer 240 is illustrated and may include at least one of a syntax verifier 510, a semantic verifier 520, and a runtime verifier 530.

The verifier 242 may receive an optimized low-level virtual machine (LLVM) IR provided from the LLM as an input and perform sequential verification for each stage. Respective verification stages may be implemented independently, and when an error occurs, corresponding information along with the cause of the error may be transmitted to the LLM for use in a correction request.

In an example, the LLVM IR may be an IR language used in an LLVM compiler framework and may be a code format that abstracts source code written in a high-level programming language into a platform-independent format. The LLVM IR may be generated by frontends for various languages such as C, C++, Rust, and Swift and may be used as a basis for various subsequent optimization tasks and hardware-specific code generation. The LLVM IR may support both human-readable text and binary forms and include a balanced mix of high-level language structures and low-level instruction representations. Thus, the LLVM IR may have a structure that is suitable for compiler analysis and conversion. Herein, the LLVM IR is used as an example for ease of description, but examples are not limited thereto, and various forms of IR’s may be applied.

The syntax verifier 510 may verify whether an input LLVM IR has a structure that conforms to grammar rules. For example, the syntax verifier 510 may detect grammatical errors such as variable declaration format errors, type mismatches, missing parentheses, and the like and may specify the position and content of an error by generating a message such as "expected type" as shown in FIG. 5.

The semantic verifier 520 may verify whether the same semantic operation as an original program is performed based on an IR that passes syntactic verification. For example, a case in which an optimized program does not reach a legitimate end point or a code flow is unnecessarily changed may be detected. As illustrated in FIG. 5, an error message such as "The source program doesn't reach a return instruction." may be generated.

The runtime verifier 530 may simulate actual execution based on dummy input data for an IR that passes semantic verification and detect inconsistency with an expected output value. For example, when the original IR outputs B for an input value A, while an optimized IR outputs C, a result such as "Output value mismatch!" may be generated. This verification allows the review of an execution path that is identical to an actual operation of a program.

At each verification stage, when an error occurs, the verifier 242 may transmit a corresponding error message including an occurrence point and cause information to an LLM. Based on this, the LLM may regenerate a modified IR. The modified IR may be re-verified, through an iterative process, through the same verifier 242. This iterative process may be performed as long as a preset constraint condition is not exceeded.

The verifiers may be implemented independently as processing elements or may be executed sequentially within a single hardware processor or software program. The verifier 242 may play a role in ensuring the accuracy and stability of an optimized IR.

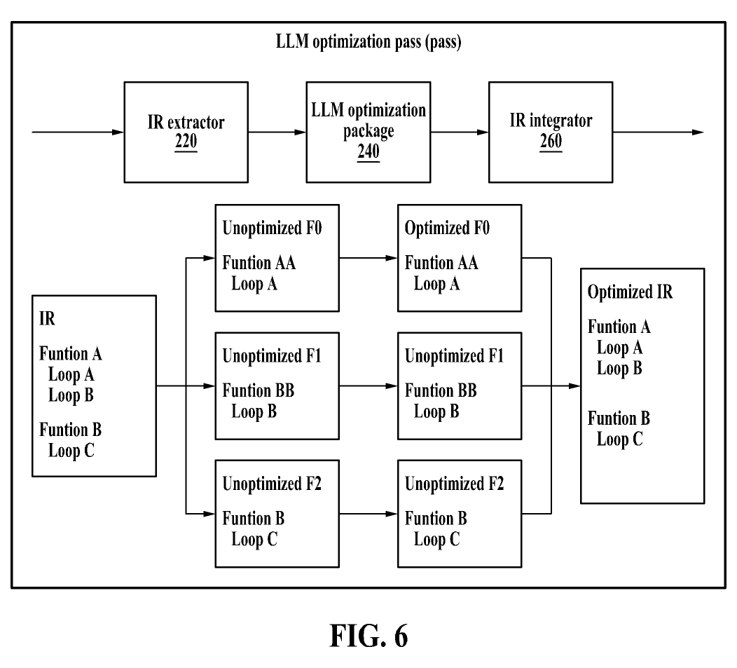

FIG. 6 illustrates an example process of a compiler pass including an LLM optimizer according to one or more embodiments.

The description provided with reference to FIGS. 1- 5 may apply to FIG. 6, and any repeated description related thereto may be omitted.

Referring to FIG. 6, in a non-limiting example, an optimization pass of a compiler is illustrated. In the optimization pass, a plurality of first IRs (e.g., first IR 230) may be extracted, LLM-based optimization may be performed on each of the plurality of first IRs, and a final IR may be generated by integrating the plurality of first IRs. For example, an IR provided as an input may include a function A and a function B. The function A may include a loop A and a loop B. The function B may include a loop C.

In an example of the optimization pass, an electronic device (e.g., electronic device 900) may first identify the loop A, the loop B, and the loop C as respective optimization units through the IR extractor 220 and may extract the loops as independent code units. The loops may be predetermined blocks within a function, but each loop may be converted into a separate function form and separated into new structures such as F0, F1, and F2 to be used as an input unit for the LLM optimizer 240. For example, the loop A may be reorganized into "the loop A within a function AA", the loop B may be reorganized into "the loop B within a function BB", and the loop C may be reorganized into "the loop C within a function B". Accordingly, the plurality of first IRs 230 (unoptimized F0, unoptimized F1, and unoptimized F2) may be generated.

The electronic device may transmit the generated plurality of first IRs to the LLM optimizer 240. The LLM optimizer 240 may generate a prompt for each input, transmit a request for optimization to an LLM, and obtain the optimized second IR (e.g., second IR 250). Each optimization result may be generated as a corresponding structure such as optimized F0, optimized F1, and optimized F2, and optimization such as operation reorganization for each loop block, removal of unnecessary instructions, improvement of repetition conditions, and the like may be applied.

The plurality of second IRs for which optimization is completed may be transmitted to the IR integrator 260 and may be inserted to a corresponding region within the existing first IR. In an example, the IR integrator 260 may re-align structures such as the functions AA and BB to their original IR positions and finally merge the structures into a single IR structure to generate an optimized IR. In this case, the IR integrator 260 may maintain the consistency of the entire structure so that there are no operational conflicts, scope errors, or control flow conflicts between a plurality of optimization results.

The finally generated optimized IR (i.e., the Optimized IR of FIG. 6) may include the function A and the function B. The loop A and the loop B may be inserted into the function A, and the loop C may be inserted into the function B. As illustrated in FIG. 6, this process may be configured to process the plurality of first IRs in parallel and integrate a plurality of corresponding optimization results sequentially or in parallel.

If some of the generated plurality of second IRs fail to pass verification, the electronic device may not include IRs that have failed their verification in a final IR. For example, when optimized F2 corresponding to the loop C has an error in a verification process or fails to secure semantic/logical consistency, the electronic device may maintain the existing first IR (unoptimized F2) or the original IR within the initial IR for the corresponding loop. This technique may ensure stability during the entire optimization process and ensure that some optimization failures do not affect the reliability of the entire IR.

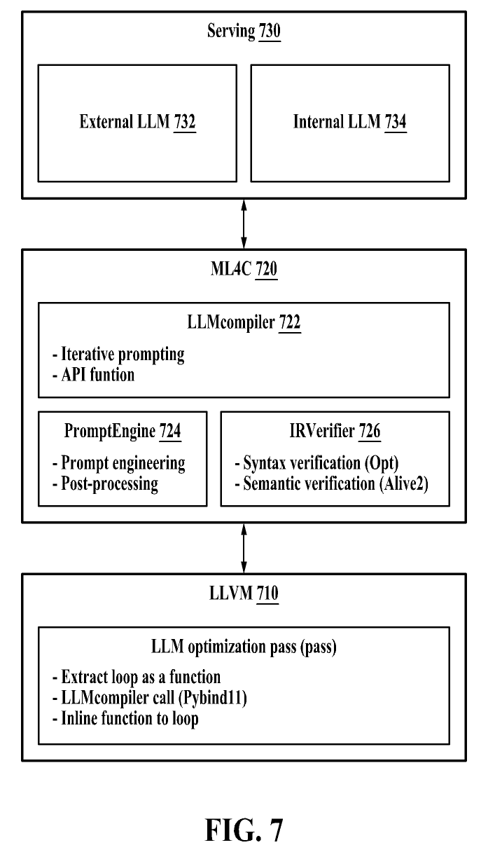

FIG. 7 illustrates an example result of an IR optimization according to one or more embodiments.

Referring to FIG. 7, in a non-limiting example, an example in which an LLM-based optimization function is integrated into an open source LLVM compiler is illustrated. The overall structure may include an LLVM 710, a machine learning for compiler (ML4C) 720, and serving 730 and may be connected to one another to perform IR optimization using an LLM.

In an example, the LLVM 710 may be an implementation unit on the compiler side. Herein, the LLVM 710 may separately define an LLM optimization pass to extract a loop as a function unit within a compiler pipeline, call the ML4C 720, and inline an optimized result back into a loop form and integrate the optimized result into the original structure. An LLM optimization pass may be configured in the same way as other passes of the LLVM 710 and thus, may be inserted and executed without affecting the existing compiler structure.

In an example, the ML4C 720 may be a core processing module of an LLM optimization function and may include three components including LLMCompiler 722 (e.g., the optimizer 241), PromptEngine 724 (e.g., the prompter 243), and IRVerifier 726 (e.g., the verifier 242). The LLMCompiler 723 may perform iterative prompt request and response processing and may be connected to the LLM via an API-based function call. For example, the LLMCompiler 723 may try different optimization scenarios for loop code and analyze responses to select an optimal result.

The PromptEngine 724 may generate a prompt to be transmitted to the LLM and perform post-processing on an LLM response result. A prompt may be configured by considering loop structures, repetition conditions, variable usage patterns, and the like and may be designed so that the LLM may clearly understand an optimization intention.

The IRVerifier 726 may perform syntactic verification and semantic verification on the optimization result received from the LLM. The syntactic verification may be performed using, for example, an opt tool, and the semantic verification may perform comparison precisely using an external tool such as Alive2. The IRVerifier 726 may control the LLMCompiler 722 to enable a re-request for additional corrections by analyzing the cause of an error when the error occurs and transmitting the cause of the error to the LLMCompiler 722.

In an example, a serving processing element (i.e., the serving 730) may be an execution environment in which an actual LLM is disposed and may support both external LLM’s 732 and internal LLM’s 734. The ML4C 720 may be connected to a commercial or open source LLM by directly calling an internal LLM instance (e.g. LLaMa, Phi, DeepSeek, etc.) or by calling an external API as a service (APIaaS) (e.g. Perplexity, ChatGPT, Claude, etc.).

LLM-based IR optimization may be integrated into a real compiler environment, allowing a user to apply an artificial intelligent (AI)-based optimization function to a compiler without changing the existing compilation flow.

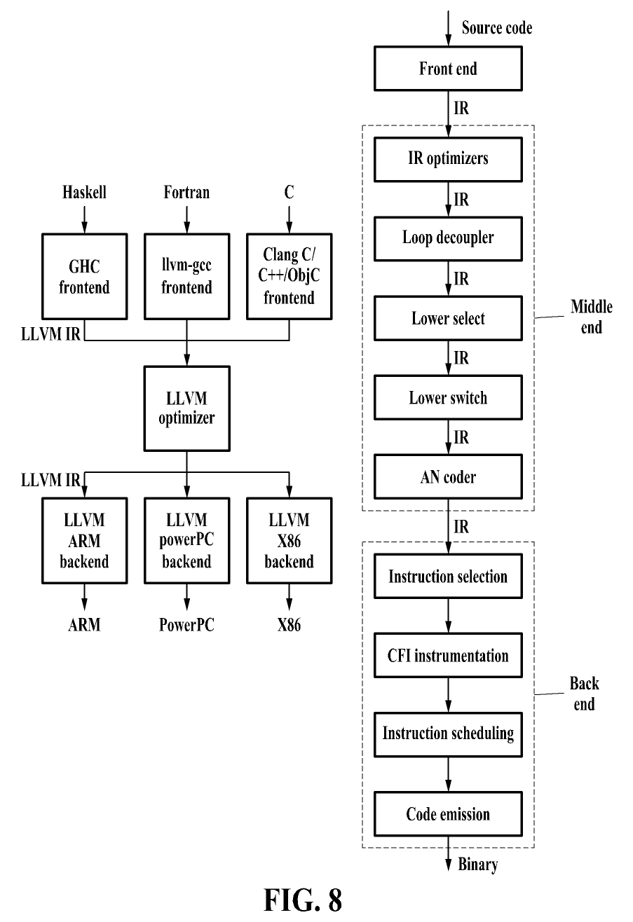

FIG. 8 illustrates an example low-level virtual machine (LLVM)-based compiler architecture according to one or more embodiments.

The description provided with reference to FIGS. 1 - 7 may apply to FIG. 8, and any repeated description related thereto may be omitted.

Referring to FIG. 8, in a non-limiting example, a structure of a general compilation process is illustrated in which an LLVM IR generated through front ends of various programming languages passes through an LLVM optimizer (e.g., the optimizer 241) and is then transmitted to a back end suitable for each hardware architecture.

The LLVM optimizer used herein may be responsible for optimizing an IR, and the optimizer may be integrated into the middle end of the compiler. Therefore, the LLM-based optimization function may also be positioned in the middle end as part of the LLVM optimizer, which may be applied within the existing compiler flow.

FIG. 9 illustrates an example electronic device according to one or more embodiments.

The description provided with reference to FIGS. 1 - 8 may also apply to FIG. 9, and any repeated description thereof may be omitted.

Referring to FIG. 9, in a non-limiting example, the electronic device 900 may include a processor 930, a memory 950, and an output device 970 (e.g., a display). The processor 930, the memory 950, and the output device 970 may be connected to one another via a communication bus 905. The electronic device 900 may include the processor 930 for performing at least one method described above or an algorithm corresponding to the at least one method, for operating the electronic device 900.

The output device 970 may display an interface and an image related to a method of operating a compiler provided by the processor 930. The output device 970 may be the same device as a display included in the electronic device 900. In addition, the output device 970 may be embedded in the electronic device 900 to display a user interface or may be an external display device.

The memory 950 may store data related to the method of operating the compiler performed by the processor 930. Furthermore, the memory 950 may store various pieces of information generated in the processing of the processor 930 described above. The memory 950 may include computer-readable instructions. The processor 930 may be configured to execute computer-readable instructions, such as those stored in the memory 950, and through execution of the computer-readable instructions, the processor 930 is configured to perform one or more, or any combination, of the operations and/or methods described herein. In addition, the memory 950 may store a variety of data and programs. The memory 950 may include a volatile memory or a non-volatile memory. The memory 950 may include a high-capacity storage medium such as a hard disk to store a variety of data.

Also, the processor 930 may perform one or more of the methods described with reference to FIGS. 1 - 9 or an algorithm corresponding to one or more of the above identified methods. In the above-described process, the processor 930 may be a hardware-implemented data processing device having a circuit that is physically structured to execute desired operations. The processor 930 may be configured to execute programs or applications to configure the processor 930 to control the electronic apparatus 900 to perform one or more or all operations and/or methods involving compiler operations as described above, and may include any one or a combination of two or more of, for example, a central processing unit (CPU), a graphics processing unit (GPU), or a neural network processing unit (NPU). The electronic device 900 that is implemented as hardware may include, for example, a microprocessor, a CPU, a processor core, a multi-core processor, a multiprocessor, an application-specific integrated circuit (ASIC), and a field-programmable gate array (FPGA).

The processor 930 may execute a program and control the electronic device 900. Program code to be executed by the processor 930 may be stored in the memory 950.

The electronic devices, processors, memories, neural networks, LLM’s, IR extractor 220, LLM optimizer 240, IR integrator 260, optimizer 241, verifier 242, prompter 243, syntax verifier 510, semantic verifier 520, LLM verifier 530, electronic device 900, processor 930, and memory 950 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-9 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
extracting a first intermediate representation (IR) corresponding to predetermined code regions by identifying the predetermined code regions in an initial IR;
providing the extracted first IR to a large language model (LLM) to obtain a second IR;
performing multi-stage verification on the second IR; and
integrating, into the initial IR, the second IR responsive to a completion of the multi-stage verification to generate a third IR.

2. The method of claim 1, wherein the performing of the multi-stage verification comprises:
responsive to an error being found during the multi-stage verification, repeatedly generating and re-verifying a modified second IR by correcting the error using the LLM.

3. The method of claim 2, wherein the repeatedly generating and re-verifying comprises:
performing verification while within a range of a preset constraint condition.

4. The method of claim 1, wherein the performing of the multi-stage verification comprises:
performing syntactic analysis on the second IR to determine a presence of a grammatical error.

5. The method of claim 1, wherein the performing of the multi-stage verification comprises:
semantically verifying whether a second functional operation of the second IR is the same as a first functional operation of the first IR.

6. The method of claim 1, wherein the performing of the multi-stage verification comprises:
evaluating logical consistencies of the second IR to identify one or more of a conflict and inconsistency between IRs.

7. The method of claim 1, wherein the performing of the multi-stage verification comprises:
identifying, through a runtime simulation, an operation of the second IR based on input data.

8. The method of claim 1, wherein the providing of the extracted first IR comprises:
generating a prompt corresponding to the extracted first IR; and
providing, to the LLM, the extracted first IR and the prompt.

9. The method of claim 1, wherein the integrating comprises:
inserting an error-free second IR, responsive to an error free result of the multi-stage verification, to the initial IR.

10. The method of claim 1, further comprising:
responsive to the multi-stage verification exceeding a preset constraint condition:
terminating the multi-stage verification; and
integrating, into the initial IR, a first code region of the first IR corresponding to a failed code region of the second IR for which the multi-stage verification fails.

11. The method of claim 1, further comprising:
responsive to the multi-stage verification exceeding a preset constraint condition:
terminating the multi-stage verification; and
maintaining the initial IR corresponding to the second IR for which the multi-stage verification fails.

12. The method of claim 1, wherein the extracting of the first IR comprises:
extracting the first IR at an arbitrary optimization pass position in a pipeline of a compiler.

13. The method of claim 1, wherein the predetermined code regions comprise one of a function, a loop, or a pragma.

14. The method of claim 1, further comprising:
providing the third IR is to a pipeline of a compiler to be processed in a subsequent pass of the compiler.

15. An electronic device, comprising:
one or more processors comprising processing circuitry; and
a memory comprising one or more storage media storing instructions that, when executed individually or collectively by the one or more processors, cause the electronic device to: extract a first intermediate representation (IR) corresponding to predetermined code regions by identifying the predetermined code regions in an initial IR;
provide the extracted first IR to a large language model (LLM) to obtain a second IR;
perform multi-stage verification on the second IR; and
integrate, into the initial IR, the second IR responsive to a completion of the multi-stage verification to generate a third IR.

16. The electronic device of claim 15, wherein the execution of the instructions causes the electronic device to:
responsive to an error being found during the multi-stage verification, iteratively generate and re-verify a modified second IR by correcting the error using the LLM.

17. The electronic device of claim 16, wherein the execution of the instructions causes the electronic device to:
perform verification while within a range of a preset constraint condition.

18. The electronic device of claim 15, wherein the execution of the instructions causes the electronic device to:
generate a prompt corresponding to the extracted first IR; and
provide, to the LLM, the extracted first IR and the prompt.

19. The electronic device of claim 15, wherein the execution of the instructions causes the electronic device to:
insert an error-free second IR, responsive to an error free result of the multi-stage verification, to the initial IR.

20. A non-transitory, machine-readable storage medium storing instructions that, when executed by one or more processors, cause the one or more processors to perform a method comprising:
extracting a first intermediate representation (IR) corresponding to predetermined code regions by identifying the predetermined code regions in an initial IR;
providing the extracted first IR to a large language model (LLM) to obtain a second IR;
performing multi-stage verification on the second IR; and
integrating, into the initial IR, the second IR responsive to a completion of the multi-stage verification to generate a third IR.
